(19) United States
(12) Patent Application Publication
(10) Pub. No.: US 2002/0142155 A1
(43) Pub. Date: Oct. 3, 2002

(54) Decorative substrate for removably adhering to a window and/or wall

(76) Inventor: Richard F. Steinberg, Riverwoods, IL (US)

Correspondence Address: RICHARD C. HIMELHOCH, 311 S. WACKER DRIVE, 53RD FLOOR, CHICAGO, IL, 60606-6622, US

(21) Appl. No.: 09/818,745

(22) Filed: Mar. 27, 2001

Related U.S. Application Data
(60) Provisional application No. 60/267,461, filed on Feb. 8, 2001.

(51) Int. Cl. B32B 7/12; B32B 15/04

(52) U.S. Cl. 428/343; 428/354

(57) ABSTRACT

A decorative substrate that can be removably adhered to a surface, such as a wall or a window. The substrate is formed from a clear or translucent film having a low-tack adhesive applied to one side. Layers of ink are applied to an opposite side to create a decorative image. The substrate can be removed from a first position on a wall or window without damaging that position, and can be remounted to another surface. The combination of the film and ink layers allows light to transmit through the substrate when mounted to a window, or to reflect from the substrate when mounted to an opaque surface, in unique manners that enhances the visual effect of the decorative image. Additionally, this combination allows the decorative image to be visible from the other side when mounted to a window.

### RELATED APPLICATIONS

The present application claims priority from U.S. Provisional Patent Application No. 60/267,461, filed Feb. 8, 2001.

### TECHNICAL FIELD

The present invention is generally directed to a substrate that can be removably attached to another medium such as a wall or a window, and more particularly, the invention is directed to a substrate having an adhesive that allows the substrate to be removably adhered to a wall or a window, the substrate also having a decorative appearance that advantageously either transmits or reflects light to enhance the appearance.

### BACKGROUND OF THE INVENTION

Decorative wall mountings such as pictures and posters, are typically affixed to a wall in a manner that damages the wall, requiring repair if the mounting is later removed. In this regard, a framed picture requires mounting brackets that are typically anchored into the wall. The larger the frame, the more extensive the brackets. Posters require thumbtacks that leave holes in the wall, or tape that may damage the paint. Moving a picture or poster from one position on a wall to another, or to another wall altogether, requires remounting the picture or poster, thus effecting another portion of the wall.

Other decorative media, such as stickers or wall paper, are also problematic when one desires to remove and/or reposition such works. Stickers will damage the paint on a wall, and are often unusable if removed from an initial mounting location. This is because the removal process often results in a tear in the sticker, excessive curling, or damage to the tacky side of the sticker. Wall paper is also difficult and costly to remove, and often requires extensive repair to the wall.

None of the aforementioned media have the flexibility and ease of use presently desired. As disclosed herein, the present invention has the multi-use capability and properties that provide advantages over such conventional decorative works.

### SUMMARY OF THE INVENTION

The present invention is directed toward a decorative substrate that can be adhered to a medium, such as a wall or a window, and can be removed and re-adhered at a different location without damage to the medium or the substrate. The invention is also directed to a method for positioning and repositioning a decorative substrate.

In one embodiment, the invention is a decorative substrate for removably mounting on a surface. The substrate comprises a translucent film layer, one or more layers of ink printed on the film layer to provide a decorative design or image, and an adhesive layer bound to the film layer. The adhesive layer is adapted to removably adhere to a surface. Thus, the substrate can be positioned on a first surface, and then removed and remounted to a second surface. This is accomplished without damaging the surfaces. The film layer may be vinyl, polyester, styrene, or PVC.

The substrate is adapted to adhere to a glass surface or to an opaque surface, such as a wood surface or a painted wall.

The substrate may further comprise a polycarbonate backing sheet removably disposed against the adhesive. The backing sheet prevents the substrate from adhering to surfaces, or collecting dust or dirt between uses.

The ink applied to the film may be UV based, oil based or soybean based. Moreover, the substrate may include a plurality of layers of inks to form the decorative design. The inks may be semi-transparent allowing sufficient light to pass through to provide a backlit effect when adhered to a window. Further, a phosphorescent ink can be printed on the film to provide a glow in the dark effect. Additionally, a layer of laminating film can be bound to a surface or side of the film opposite the surface or side bound to the adhesive to further enhance and protect the decorative image.

According to another embodiment, the present invention is a method of providing decorative art to a surface. The method comprises forming a decorative substrate including providing a translucent film, printing a decorative design on a first side of the film, coating a second side of the film opposite the first side with an adhesive adapted to removably adhere to a surface. The method further comprises adhering the substrate to a first surface utilizing the adhesive, and removing the substrate from the first surface and adhering the substrate to a second surface utilizing the adhesive. The method may further include removing the substrate from the second surface and adhering the substrate to a third surface. This process can be repeated indefinitely. The surfaces can be either a wall or a window; however, many other surfaces can also be utilized to mount the substrate to.

Further aspects of the invention are disclosed in the detailed description of the preferred embodiment, the drawings and the claims.

### BRIEF DESCRIPTION OF THE DRAWINGS

FIG. 1 is a perspective view of a decorative substrate of the present invention being peeled from a protective backing layer;

FIG. 2 is a partial enlarged cross-sectional view of the substrate of FIG. 1;

FIG. 3 is a perspective view of the substrate of FIG. 1 mounted onto a wall;

FIG. 4 is a perspective view of the substrate of FIG. 1 mounted to a glass window of a door frame; and,

FIG. 5 is a perspective view of the substrate of FIG. 1 mounted onto the opposite side of the door of FIG. 4.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention relates to a vinyl or plastic substrate such as styrene, polyester, PVC, or any other clear or translucent substrate, that will hold ink, using lithographic and other printing techniques. The substrate, when inked and applied with a reusable adhesive, can be used to form a decorative piece of art that can be removably mounted to a window or a wall (sometimes referred to herein as “window wall art”).

In its preferred form, the window wall art combines a durable substrate; with a removable, reusable adhesive; and specialized printing techniques. The product then has the capability of mounting to windows and non-porous surfaces as well as walls and other porous surfaces. Moreover, the product is removable. That is, the product can be peeled off of a first surface (e.g., glass) and remounted to a second surface (e.g., a wall), without causing damage to the surface or to the substrate.

Additionally, because of the unique combination of materials and inking processes, the product can be displayed using transmitted light such as the light emanating from behind a window or other clear or translucent surfaces that the product is mounted to. When displayed on walls and other opaque surfaces, the window wall art works with reflected light. Being completely removable the product can be transferred from surface to surface with no degradation of the substrate or the graphics.

The window wall art is preferably manufactured using a 0.0065 inch clear or translucent vinyl. The preferred vinyl is made by the Lamart Corporation, located in Clifton, N.J. The vinyl has a non-water soluble, removable adhesive applied and then is back lined with a 90# polycarbonate backing sheet. The backing sheet remains with the product until actual usage where it is removed to expose the adhesive to its mounting surface.

Printing is done using offset lithography. It can also be done with screen printing, flexography and other print processes. The preferred printing process includes using a 4 color process or special color matched inks, opaque white ink, and aqueous coating. The inks are preferably UV based inks, conventional oil based inks, and soybean inks.

To print a decorative design or image onto the film, the vinyl material is preferably loaded into the feeder of a 28×40 Heidelberg 6 color press. As the material is sent sheet by sheet into the press it receives a specific color in each printing unit. At the end of the first pass it has received up to 5 colors plus 1 pass of opaque white. The second time through the press it receives the white first and then a repeat of the colors put on in the first pass. After printing the material is cut; die-cut; kiss die-cut; or laminated. The process thus includes printing multiple colors for the graphics, 1-2 white inks, and a repeat of the colors used for the graphics. This forms a “sandwich” of white in the middle for opacity and depth.

Referring to FIG. 1, a substrate 10 of the present invention is shown having a decorative design. In this instance, the decorative design is a frog clinging to a leaf. However, limitless designs are available.

The substrate 10 is shown being partially peeled from a backing sheet 12. As set forth above, the backing sheet is preferably a 90# polycarbonate sheet. The backing sheet prevents the adhesive on the substrate from coming into contact with dust, dirt or other objects when not mounted to a wall, and facilitates transport of the substrate 10.

The substrate is formed from a clear or translucent vinyl film 14 capable of holding ink. The ink is applied in layers 16-38 to one side of the film 14 as shown in cross-section in FIG. 2 (the thicknesses of the ink layers has been exaggerated for purposes of illustrating the invention). The ink layers are applied one color at a time. In the preferred embodiment disclosed in FIG. 2, the first five layers 16, 18, 20, 22 and 24 of color are applied followed by a first layer 26 of opaque white. This is followed by a second layer 28 of opaque white followed again by the five layers 30, 32, 34, 36 and 38 of color. The effect of the first and second opaque white layers 26 and 28, enhances the decorative image printed on the film 14, especially the quality of depth of the image.

An adhesive layer 40 is applied to the opposite side of the film layer 14. When not adhered to a medium such as a wall or window, the backing 12 covers and protects the adhesive layer 40 from contact. The adhesive layer is preferably a 306 removable adhesive, also available from Lamart Corporation. The adhesive is preferably a lowtack, removable acrylic pressure-sensitive adhesive. The adhesive layer 40 is approximately 0.001 inches thick.

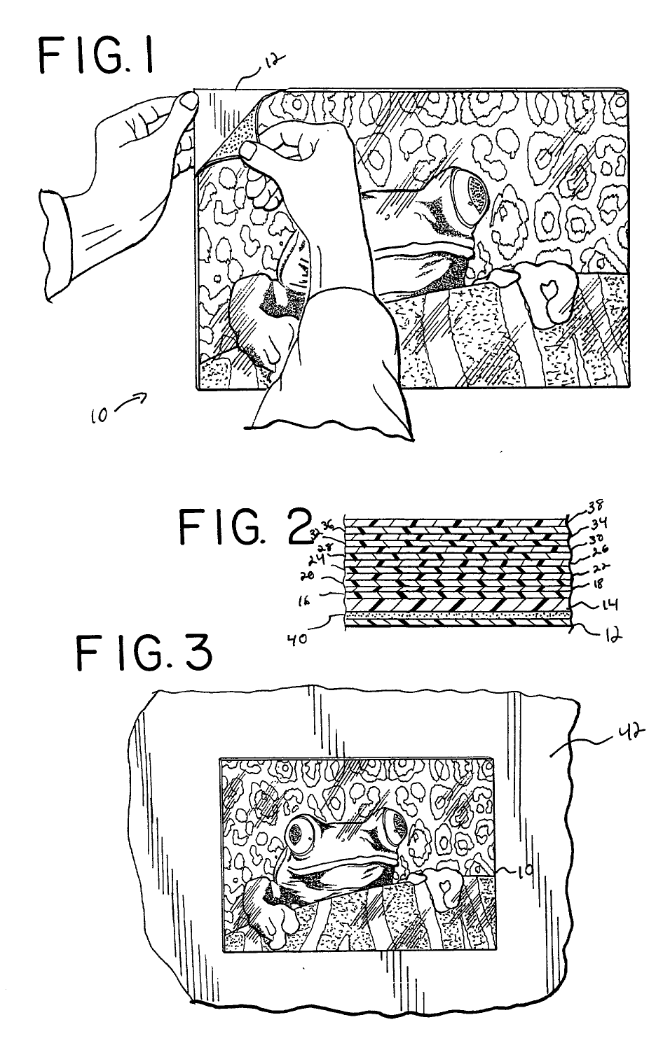

Once peeled from the backing 12, the substrate 10 can be adhered directly to a wall 42, as shown in FIG. 3. When mounted to an opaque surface like a wall, the combination of the clear or translucent film with the inking process described above, reflects light in a unique manner that enhances the decorative image.

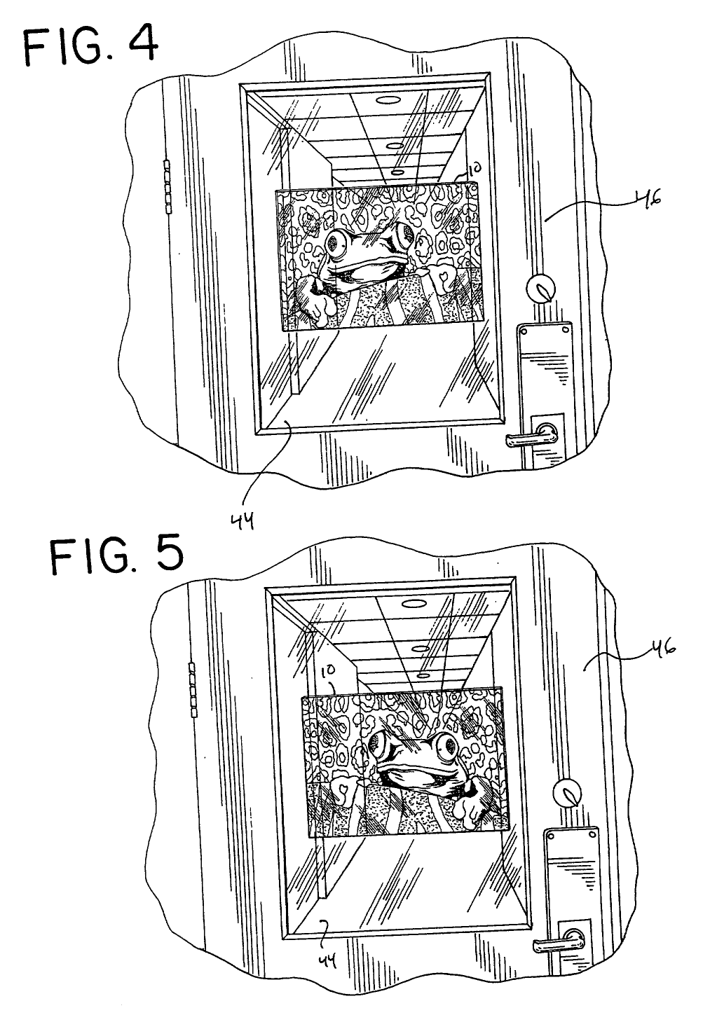

The substrate 10 can be peeled off the wall 42, and be remounted at another location on the wall 42, or to another surface. For example, the substrate 10 can be adhered to a glass window 44 of a door 46 as shown in FIG. 4. In this environment, the clear or translucent nature of the vinyl film 14, along with the nature of the inks, allows light from behind the substrate to transmit through the substrate 10 creating another unique lighting effect.

Additionally, the clear vinyl layer 14 combined with the preferred inking process, allows the decorative image to be seen from either side when mounted to glass. As shown in FIG. 5, the mirror image of the frog is visible when the substrate 10 is mounted to the opposite side of the door 46 The substrate 10 is moveable and reusable as described above. Due to the properties of the low-tack adhesive, the product can be used on walls, windows, and other porous and non-porous surfaces without damaging the surface it is applied to.

Additionally, the substrate 10 advantageously utilizes transmitted and/or reflected light to enhance the visual effect of the decorative image printed on the substrate 10. Because of the semi-transparent nature of the inks used in the process, the finished product allows light to pass through the material and the ink, to add a strong backlit effect when adhered to a clear surface, making the colors appear brighter and stronger. Also, because of the multiple layers of ink combined with the white “sandwich,” the finished product demonstrates reflected light properties when applied to an opaque surface. The reflected light provides a full, rich looking image when viewed in this manner.

The substrate 10 forming the window wall art can be manufactured in a variety of sizes. On the preferred press, the sizes can range from 1″×1″ up to 28″×40″. The substrate 10 can be die-cut into various shapes and sizes. The material can be cut to a specific shape or can be kiss die-cut as a peel up from a larger size piece.

Additionally, “glow in the dark” phosphorescent inks can be used in various applications on the product. The ink can be applied via offset lithography, screen printing, flexography, or letterpress.

Further, laminating-film and UV laminates can be applied to the product for further effect. Both laminates add gloss and further protection to the printed surface to prevent or limit scratching or marking.

While specific embodiments have been illustrated and described, numerous modifications are possible without departing from the spirit of the invention, and the scope of protection is only limited by the scope of the accompanying claims.

I claim:

1. A decorative substrate for removably mounting on a surface comprising:
a translucent film layer;
a layer of ink printed on said film layer to provide a decorative design; and, an adhesive layer bound to said film layer, said adhesive layer adapted to removably adhere to a surface.

2. The substrate of claim 1 wherein said substrate is adapted to adhere to a glass surface.

3. The substrate of claim 1 wherein said substrate is adapted to adhere to a wood surface.

4. The substrate of claim 1 wherein said substrate is adapted to adhere to a wall.

5. The substrate of claim 1 wherein said film comprises vinyl.

6. The substrate of claim 1 wherein said film comprises polyester.

7. The substrate of claim 1 wherein said film comprises styrene.

8. The substrate of claim 1 wherein said film comprises PVC.

9. The substrate of claim 1 further comprising a polycarbonate backing sheet removably disposed against said adhesive.

10. The substrate of claim 1 wherein said ink is UV based.

11. The substrate of claim 1 wherein said ink is oil based.

12. The substrate of claim 1 wherein said ink is soybean based.

13. The substrate of claim 1 further comprising a plurality of layers of inks to form said decorative design.

14. The substrate of claim 1 wherein said ink is semi-transparent allowing sufficient light to pass through the film to provide a backlit effect when adhered to a window.

15. The substrate of claim 1 further comprising a phosphorescent ink printed on said film.

16. The substrate of claim 1 further comprising a layer of laminating film bound to a surface of said film opposite said surface bound to said adhesive.

17. A method of providing decorative art to a surface comprising:
forming a decorative substrate including
providing a translucent film;
printing a decorative design on a first side of said film;
coating a second side of said film opposite said first side with an
adhesive adapted to removably adhere to a surface;
adhering said substrate to a first surface utilizing said adhesive; and,
removing said substrate from said first surface and adhering said substrate to a second surface utilizing said adhesive.

18. The method of claim 17 wherein said adhering said substrate to a first surface comprises adhering said substrate to a window.

19. The method of claim 17 wherein said adhering said film to a first surface comprises adhering said substrate to a wall.

20. The method of claim 17 further comprising removing said substrate from said second surface and adhering said substrate to a third surface.
